(19) United States
(12) Patent Application Publication
(10) Pub. No.: US 2007/0225440 A1
(43) Pub. Date: Sep. 27, 2007

(54) Impact modified polystyrene and process for preparing same

(75) Inventors: Jose M. Sosa, Deer Park, TX (US); Kenneth P. Blackmon, Houston, TX (US); Doug A. Berti, Nassau Bay, TX (US)

Correspondence Address: David J. Alexander, P.O. Box 674412, Houston, TX, 77167, US

(73) Assignee: Fina Technology, Inc., Houston, TX (US)

(21) Appl. No.: 11/728,447

(22) Filed: Mar. 24, 2007

Related U.S. Application Data
(63) Continuation of application No. 10/729,446, filed on Dec. 5, 2003, now abandoned.
(63) Continuation-in-part of application No. 10/674,224, filed on Sep. 29, 2003.

(51) Int. Cl. C08L 51/00

(52) U.S. Cl. 525/64

(57) ABSTRACT

Disclosed is a composition comprising an impact modified polystyrene prepared using a process comprising dissolving a styrene-butadiene-styrene block copolymer in styrene monomer and polymerizing the styrene monomer wherein the impact modified polystyrene has a haze value of less than or equal to 12 percent. Also disclosed is an impact modified polystyrene prepared using the same process and having a ratio of Mz/Mn of at least 4.1.

### CROSS-REFERENCE TO RELATED APPLICATIONS

This application is a continuation in part of copending U.S. patent application Ser. No. 10/674,224, filed Sep. 29, 2003, which is assigned to the assignee of this application.

### BACKGROUND OF THE INVENTION

1. Field of the Invention

The present invention relates to polystyrene. The present invention particularly relates to clear impact modified polystyrene, sometimes referred to as “CLIPS.”

2. Background of the Art

Polystyrene is one of the largest volume thermoplastic resins in commercial production today. Unmodified polystyrene is well suited to applications where its brittleness is acceptable. Engineering plastics have been used in applications where less brittleness is required, but such polymers are often expensive or have properties other than less brittleness that make them less than optimum selections. Thus, styrene-based copolymers, and particularly polystyrene resins that are modified with organic rubber particles, have been investigated for use in applications requiring less brittleness. The modification of polystyrene to reduce brittleness is often referred to increasing its impact properties and thus the modified polystyrene is said to have higher impact.

These high-impact polystyrene blends, commonly referred to by the acronym HIPS, are known to be useful in the art of preparing articles with polymers wherein the application for the articles requires less brittleness than unmodified polystyrene. For example, U. S. Defensive Publication T59,011 to Smith discloses that a high impact resin can be prepared by blending from 15 to 50 parts of an impact modifier with from 85 to 50 parts of a clear crystal polystyrene. Such materials are disclosed to be useful for packaging applications.

Another method of making HIPS is to first dissolve a rubber in styrene monomer and then polymerize the monomer. Such polymers are disclosed in U.S. Pat. No. 6,569,941 Sosa, et al. Therein, it is disclosed that styrene monomer containing a dissolved polybutadiene rubber is flowed into an elongated upflow stirred reactor containing three reaction zones, wherein the styrene monomer is polymerized to form a HIPS.

In addition to modifying styrene with rubber, it has been disclosed to modify styrene using block copolymers. In U.S. Pat. No. 6,362,283, to Wollum, a process is disclosed for interpolymerizing a vinyl aromatic hydrocarbon polymer and a block polymer. The process includes forming a block polymer precursor of at least one polymeric block containing conjugated diene monomer contributed units in the presence of an anionic initiator and in an inert diluent. The block polymer precursor having living ends is adding to a charge of a vinyl aromatic hydrocarbon monomer and an additional charge of an anionic initiator to simultaneously form a block polymer having a terminal block formed from the charge of vinyl aromatic hydrocarbon monomer attached to the block polymer precursor and a poly(vinyl aromatic hydrocarbon) polymer interpolymerized with the block polymer.

### SUMMARY OF THE INVENTION

In one aspect, the present invention is impact modified polystyrene. The impact modified polystyrene is prepared using a process including dissolving a styrene-butadiene-styrene block copolymer in styrene monomer and polymerizing the styrene monomer wherein the clear impact modified polystyrene has a haze of less than or equal to 12 percent.

In another aspect, the present invention is a process for preparing an impact modified polystyrene. The process includes dissolving a styrene-butadiene-styrene block copolymer in styrene monomer and polymerizing the styrene monomer wherein the impact modified polystyrene has a haze of less than or equal to 12 percent.

Another aspect of the present invention is a composition of an impact modified polystyrene prepared using a process including dissolving a styrene-butadiene-styrene block copolymer in styrene monomer and polymerizing the styrene monomer wherein the impact modified polystyrene has a ratio of Mz/Mn of at least 4.1.

Still another aspect of the present invention is a process for preparing an impact modified polystyrene including dissolving a styrene-butadiene-styrene block copolymer in styrene monomer and polymerizing the styrene monomer wherein the impact modified polystyrene has a has a ratio of Mz/Mn of at least 4.1.

Yet another aspect of the present invention is a composition of an impact modified polystyrene prepared using a process including dissolving a styrene-butadiene-styrene block copolymer in styrene monomer and polymerizing the styrene monomer wherein the impact modified polystyrene has a haze value of less than or equal to 12 percent, the styrene-butadiene-styrene block copolymer is a tapered block copolymer having a styrene content of about 70 percent, a Mw of from about 50,000 to about 250,000 Daltons, and is present at a concentration of from about 5 to abut 20 percent.

### BRIEF DESCRIPTION OF THE DRAWINGS

For a detailed understanding and better appreciation of the present invention, reference should be made to the following detailed description of the invention and the preferred embodiments, taken in conjunction with the accompanying drawings, wherein:

FIG. 1 is a graph showing the effect of block copolymer concentration on polystyrene formation with and without n-dodecyl mercaptan (NDM), a chain transfer agent; and

FIG. 2 is a graph showing the effect of block copolymer concentration on the molecular weight distribution of polystyrene with and without NDM.

### DETAILED DESCRIPTION OF INVENTION

In the practice of the method of the present invention of preparing an impact polystyrene, a styrene-butadiene-styrene copolymer is dissolved in a styrene monomer and then the styrene monomer is polymerized. This process is a solution polymerization process and can be performed in any fashion known to be useful to those of ordinary skill in the art of performing such processes. For example, the impact modified polystyrene of the present invention can be prepared using the process disclosed in U.S. Pat. No. 6,569,941 Sosa, et al., which includes using an upflow reactor. In another embodiment, the process of the present invention can be practiced using a single batch reactor.

The present invention includes dissolving a styrene-butadiene-styrene copolymer in styrene. In one embodiment of the present invention, styrene-butadiene-styrene copolymers useful with the process of the present invention are those having the general formula:
S—B—S
wherein S is styrene and B is butadiene or isoprene. In another embodiment of the present invention, the styrene-butadiene-styrene copolymers have the general formula:
(SB)ₙX.
wherein X stands for the residue of a coupling agent; and n is more than 1. In a first embodiment of the present invention wherein such a radial styrene-butadiene-styrene copolymer is used, n is an integer ranging from about 2 to about 40. In another such embodiment, n is an integer ranging from about 2 to 4 or 5. The styrene-butadiene-styrene copolymers useful with the process of the present invention can have a molecular weight ranging from about 2,000 to about 300,000 Daltons. In one embodiment of the present invention, the styrene-butadiene-styrene polymers useful with the present invention have a molecular weight of from about 50,000 to about 250,000 Daltons. In still another embodiment, the styrene-butadiene-styrene polymers useful with the present invention have a molecular weight of from about 75,000 to about 200,000 Daltons.

For purposes of the present invention, the term styrene-butadiene-styrene includes the compositions where the butadiene component is isoprene and also compositions where the butadiene element is a mixture of butadiene or another conjugated diene. While the vast majority of S—B—S copolymers utilize butadiene as the B component, any conjugated diene can be used in the present application and is within the scope of the claims.

The styrene-butadiene-styrene block copolymers useful with the present invention have a styrene content of at least 50 percent. In one embodiment, the styrene-butadiene-styrene block copolymers useful with the present invention have a styrene content of from about 60 to about 80 percent. In another embodiment, the styrene-butadiene-styrene block copolymers useful with the present invention have a styrene content of from about 65 to about 75 percent.

The styrene-butadiene-styrene block copolymers useful with the present invention may have a tapered block structure and may also be, at least in some embodiments, partially hydrogenated. In tapered block copolymers, each block should contain predominantly only one component, S or B. In each block, the presence of the non-predominant or minor component is less than 5 weight percent. If hydrogenated, then the styrene-butadiene-styrene block copolymers will have some or even most of the residual unsaturation removed from the butadiene segment of the copolymer. Examples of styrene-butadiene-styrene copolymers useful with the present invention include those sold under the trade designations FINACLEAR and FINAPRENE, sold by ATOFINA; KRATON polymers, sold by KRATON POLYMERS LLP; and K-Resins, sold by B&K Resins, Ltd.

The impact modified polystyrenes of the present invention are prepared by admixing styrene and at least one styrene-butadiene-styrene copolymer. In a first embodiment of the present invention, the styrene-butadiene-styrene copolymer is soluble in the styrene. In a second embodiment, a solvent can also be used to increase the solubility of the styrene-butadiene-styrene copolymer in the styrene monomer. Suitable solvents include aromatic solvents such as ethylbenzene, toluene, xylenes, cyclohexane, and aliphatic hydrocarbon solvents, such as dodecane, and mixtures thereof. Any solvent useful to facilitate the full or partial dissolution of a styrene-butadiene-styrene copolymer in styrene monomer that can be removed after polymerization of the styrene monomer and does not interfere with the polymerization of the styrene monomer can be used with the method of the present invention.

The admixture of styrene monomer and styrene-butadiene-styrene copolymer is further admixed with at least one polymerization initiator. The polymerization initiator can be a grafting or non-grafting polymerization initiator. Exemplary grafting initiators include peroxide initiators such as, but not limited to Lupersol® 331 (1,1-di-(t-butylperoxy)cyclohexane); Lupersole 531 (1,1-di-(t-amylperoxy)cyclohexane); Lupersol 231 (1,1-di-(t-butylperoxy)-3,3,5-trimethyl-cyclohexane); Lupersol TAEC (OO-t-amyl-O-(2-ethylbexyl monoperoxy-carbonate); Lupersol TBIC (OO-t-butyl O-isopropyl monoperoxy-carbonate); Lupersol TBEC (OO-t-butyl-O-(2-ethylhexyl)monoperoxy-carbonate); Trigonox® 17 (N-butyl-4,4-di(t-butylperoxy)valerate); and Lupersol 233 (Ethyl 3,3-Di-(t-butylperoxy)butyrate). Other initiators that can be used with the method of the present invention include peroxides with one hour half-lives ranging from 60 to 150° C. from diacyl peroxides, diazo compounds, peroxydicarbonates, peroxyesters, dialkylperoxides, hydroperoxides, and perketals. Mixtures of these initiators can also be used.

Non-grafting initiators are also used with the present invention. Exemplary non-grafting initiators include 2,2′-azobis(isobutyronitrile) (AIBN), 2,2′-azobis(2-methylbutyronitrile) (AMBN), lauroyl peroxide, and decanoyl peroxide. Mixtures of these initiators can also be used.

For the purposes of the present invention, the terms “grafting” and “non-grafting” as used above relate to the ability of an initiator to promote a both the homopolymerization of styrene and the reaction of polymerizing styrene to react with residual unsaturation in the styrene-butadiene-styrene copolymer, if any. For the purposes of the present invention, a grafting polymerization initialization initiator is one that promotes both the initialization of styrene and the reaction of styrene or polystyrene with the residual unsaturation in a styrene-butadiene-styrene copolymer. Similarly, for the purposes of the present invention, a non-grafting polymerization initialization initiator is one that promotes the initialization of styrene, but does not materially promote the reaction of styrene or polystyrene with the residual unsaturation in a styrene-butadiene-styrene copolymer.

In the practice of the process of the present invention, the grafting and/or non-grafting polymerization initiators are present in amounts useful to promote the polymerization of the styrene monomer to produce an impact modified polystyrene. In one embodiment, the grafting polymerization initiator is present in an amount of from about 50 to about 1000 ppm while the non-grafting polymerization initiator is present in an amount of from about 100 to about 600 ppm. In another embodiment, the grafting polymerization initiator is present in an amount of from about 100 to about 600 ppm while the non-grating polymerization initiator is present in an amount of from about 100 to 500 to about ppm. In the embodiments of the present invention where both types of initiators are used, the ratio of grafting to non-grafting polymerization initiator is from about 1:10 to about 10:1. In one specific embodiment, the ratio of grafting to non-grafting polymerization initiator is from about 1:3 to about 3:1.

Where only one or the other type of initiator is present, the grafting 25 initiator is present at a concentration of from about 100 to about 400ppm. If the only initiator is a non-grafting initiator, it is present at a concentration of from about 100 to about 600ppm. Selection and use of initiators is known to those of ordinary skill in the art of polymerizing styrene monomer to prepare impact modified polystyrene.

Polyfunctional initiators can also be used with the present invention. For example, in one embodiment, the present invention is an impact modified polystyrene prepared using LUPEROXR® JWEB50 as an initiator. The polyfunctional initiators can be used alone or in combination with other initiators.

In addition to chemical initiation, thermal initiation can also be used with practice of the present invention. The temperature ranges useful with process of the present invention can be selected to be consistent with the operational characteristics of the equipment used to perform the polymerization. In one embodiment, the temperature range for the polymerization can be from about 100° C. to about 230° C. In another embodiment, the temperature range for the polymerization can be from about 110° C. to about 180° C.

The impact modified polystyrenes of the present invention have a styrene concentration of at least 50 percent. In one embodiment, the impact modified polystyrenes of the present invention have a styrene concentration of from about 50 to about 80 percent. In another embodiment, the impact modified polystyrenes of the present invention have a styrene concentration of from about 60 to about 70 percent.

The impact modified polystyrenes of the present invention have a haze value of less than or equal to 12 percent a measured using ASTM D1003. The linear styrene-conjugated diene-styrene block copolymers generally have less impact on haze than radial styrene-conjugated diene-styrene block copolymers in the practice of the present invention. For example, an impact modified polystyrenes of the present invention can be prepared with a copolymer content of 50 percent an still have a very low level of haze. Any combination of copolymers can be used with the method of the present invention as long as the resultant impact modified polystyrene has a haze value of les than or equal to 12 percent. In one embodiment, the impact modified polystyrenes of the present invention can be prepared with a copolymer content of 60 percent wherein the copolymer is a mixture of linear and radial copolymers. In another embodiment, the impact modified polystyrenes of the present invention can be prepared with a copolymer content of 50 percent wherein the copolymer is a mixture of linear and radial copolymers. Another embodiment of the present invention is prepared with a copolymer content of 40 percent wherein the copolymer is a mixture of linear and radial copolymers. Embodiments of the present invention can be prepared using these levels of one type of copolymer also.

As use herein, the Mw of a polymer means the weight average molecular weight of the polymer while Mn means the number average molecular weight. In addition, in the present compositions, the increased high molecular weight polymer is reflected in the Mz value, also known as the z-average molecular weight. The impact modified polystyrenes of the present invention have a comparatively high z-average molecular weight (Mz). The Mz is the molecular weight of the extremely high molecular weight polymer chains, that is those near an upper end of the molecular weight distribution. The impact modified polystyrenes of the present invention have a z-average molecular weight of at least about 250,000 to about 3,000,000 Daltons.

The weight average molecular weight of the impact modified polystyrenes of the present invention can be calculated using the formula:

$${M}_{w} = \frac{{\sum }_{i} {N}_{i} {M}_{i}^{2}}{{\sum }_{i} {N}_{i} {M}_{i}} = \frac{{\sum }_{i} {w}_{i} {M}_{i}}{{\sum }_{i} {w}_{i}}$$

wherein Nᵢ is the number average counts and Mᵢ is the poly styrene equivalent molecular weight for the index number i.

Mn can be calculated using the formula:

$${M}_{n} = \frac{{\sum }_{i} {N}_{i} {M}_{i}}{{\sum }_{i} {N}_{i}} = \frac{{\sum }_{i} {w}_{i}}{{\sum }_{i} \frac{{w}_{i}}{{M}_{i}}}$$

wherein Nᵢ is the number average counts and Mᵢ is the poly styrene equivalent molecular weight for the index number i.

Mz can be calculated using the formula:

$${M}_{z} = \frac{{\sum }_{i} {N}_{i} {M}_{i}^{3}}{{\sum }_{i} {N}_{i} {M}_{i}^{2}} = \frac{{\sum }_{i} {w}_{i} {M}_{i}^{2}}{{\sum }_{i} {w}_{i} {M}_{i}}$$

wherein Nᵢ is the number average counts and Mᵢ is the poly styrene equivalent molecular weight for the index number i.

Another way quantifying the z-average molecular weights of the present invention is by their ratio with Mn. The impact modified polystyrenes of the present invention have a ratio of Mz/Mn of at least 4.1. In one embodiment, the impact modified polystyrenes of the present invention have a ratio of Mz/Mn of from about 5.5 to about 25. In another embodiment, the impact modified polystyrenes of the present invention have a ratio of Mz/Mn of from about 7 to about 22.

While not wishing to be bound by any theory, it is believe that during the polymerization process, the styrene monomer can react with the residual unsaturation in the butadiene segment of the styrene-butadiene-styrene copolymer. This allows for the increase in Mz molecular weight relative to the Mn weight.

The impact modified polystyrenes of the present invention can have a high clarity as compared to convention impact modified polystyrenes. In one embodiment, the impact modified polystyrenes of the present invention have a haze value of 12 percent or less. In another embodiment, the impact modified polystyrenes of the present invention have a haze value of 8 percent or less. In still another embodiment the impact modified polystyrenes of the present invention have a haze value of 6 percent or less.

The impact modified polystyrenes of the present invention can be used in any application known to be useful to those of ordinary skill in the art of preparing articles using impact modified polystyrenes. In one embodiment, the impact modified polystyrenes of the present invention are used for injection molding and have a melt flow index of from about 2 to about 6 g/10 minutes at 200° C. as measured using ASTM D1238. In another embodiment, the impact modified polystyrenes of the present invention are used for injection molding and have a melt flow index of from about 6 to about 14 g/10 minutes at 200° C.

The impact modified polystyrenes of the present invention are particularly well suited for preparing polymer foams. In preparing polymer foams, the polymer is admixed with a blowing agent and the blowing agent functions to produce cells which lower the density of the polymer. Blowing agents useful for producing polymer foams include gases and liquids that are gases under blowing conditions, such as butane, carbon dioxide, chloroflurocarbons, fluorocarbons, pentane, and hexane. The impact modified polystyrenes of the present invention have excellent melt strength which allows the polymer to more efficiently retain the blowing agents which in turns can reduce production costs by reducing processing time and raw material costs.

The impact modified polystyrenes of the present invention can be prepared using additives. Exemplary additives include fillers, chain transfer agents, talc, anti-oxidants, UV stabilizers, lubricants, crosslinking agents, mineral oil, plasticizers, and the like. Any additive known to be useful in preparing high impact polystyrenes to those of ordinary skill in the art of preparing such polymers can be used with the present invention. For example, the impact modified polystyrenes of the present invention can be prepared using NDM as a chain transfer agent. Using NDM in the process of the present invention, one of ordinary skill in the art can prepare an impact modified polystyrene with a high Mz, but avoid producing so much branching that the material cannot be processed due to the presence of gels. In one embodiment of the present invention NDM is used at a concentration of from about 50 to about 500 ppm. In another embodiment, the present invention can be prepared using divinyl benzene as a crosslinking agent.

In an embodiment of the present invention wherein there is residual monomer at the end of the polymerization of the styrene monomer, the monomer can be removed from the high impact polystyrene. In embodiments where a solvent is used, the solvent can be removed from the high impact polystyrene. Any method of removing unreacted styrene monomer and solvent, if any, known to be useful can to those of ordinary skill in the art of manufacturing high impact polystyrene can be used with the method of the present invention. After removal, the solvent and styrene monomer can be recycled or discarded.

### EXAMPLES

The following examples are provided to illustrate the present invention. The examples are not intended to limit the scope of the present invention and they should not be so interpreted. Amounts are in weight parts or weight percentages unless otherwise indicated.

### Example 1

Batch polymerization of styrene is carried out in the presence of varying concentrations of FINACLEAR 530 and FINAPRENE 602-D. FINACLEAR 530 (FC 530) is a tapered triblock styrene-butadiene-styrene copolymer having a styrene content of about 70 percent. FINAPRENE 602-D (FP 620) is a radial styrene-butadiene-styrene copolymer having a styrene content of about 40 percent. Both of these copolymers are commercially available from ATOFINA.

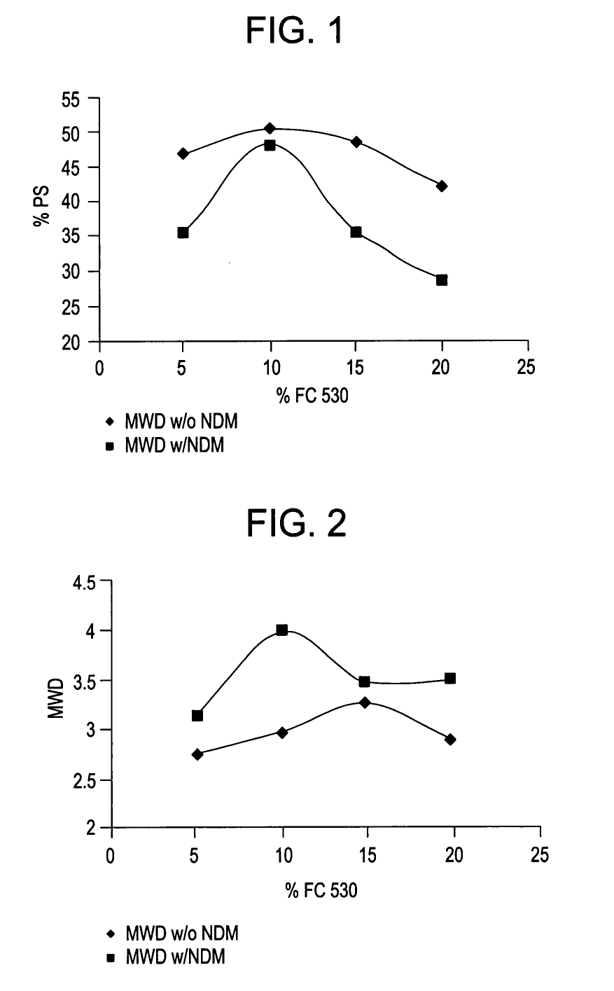

A 200 gram solution is prepared that contains 5 % EB, and 300 PPM of n-dodecyl mercaptan (NDM). The concentrations of styrene and of styrene-butadiene-styrene copolymer, as shown in Table 1, are added. The solution is heated from 110 to 180° C. until polymerization of the styrene monomer is complete. The resultant impact modified polystyrene is isolated and tested as shown in Table 1. Plots of the data can be seen in FIGS. 1 and 2. Haze values are for a 30 mil (0.762 mm) extruded sheet.

### Example 2

A solution is prepared by dissolving the percentages of FC 530 show in Table 2 in styrene. 175 ppm of LUPERSOL 233 is also present. 200 ppm of NDM is or is not present as is shown in Table 2. The solution is heated to 150° C. to polymerize 40-60% of the styrene monomer, and then the solution is devolatilized at 225° C. and held at temperature for 25 minutes at a pressure of about 1 Torr. The resultant polymer is tested for molecular weight and the results displayed in Table 2. Plots of the data can be seen in FIGS. 1 and 2.

In Example 1, it can be seen that an impact modified polystyrene can have very low haze values when prepared using a combination of an styrene-butadiene-styrene triblock and a radial styrene-butadiene-styrene copolymer. In Example 2, it can be observed that the use of a styrene-butadiene-styrene triblock, particularly at levels of from about 10 to 20 percent, can increase the Mz of the impact modified polystyrene, even when the impact modified polystyrene is prepared in the absence of a chain transfer agent. This is evident both from the data in Table 2 and the graphs in FIGS. 1 and 2.

TABLE 1

| | | | Poly- | Final | | | | | | |
|---|---|---|---|---|---|---|---|---|---|---|
| | FC 530 | FP 602D | Styrene | Solids | Melt | | | | | |
| | Percent | Percent | Percent | Percent¹ | Flow² | Haze³ | Mn⁴ | Mw⁴ | Mz⁴ | MWD⁵ |
| Example 1-1 | 48.8 | — | 51.2 | 52.1 | 5.1 | 3.2 | 110 | 256 | 506 | 2.3 |
| Example 1-2 | 46.7 | 5.2 | 48.1 | 48.2 | 3.7 | 3.3 | 103 | 363 | 1476 | 3.5 |
| Example 1-3 | 39.1 | 9.8 | 51.5 | 51.2 | 2.3 | 4.7 | 103 | 430 | 2419 | 4.2 |
| Example 1-4 | 30.4 | 20.3 | 49.3 | 49.3 | 2.4 | 8.6 | 103 | 316 | 1219 | 3.1 |
| Example 1-5* | 25.9 | 25.9 | 48.2 | 48.2 | 0.9 | 20.2 | 99 | 310 | 1544 | 3.1 |
| Example 1-6* | 20.1 | 30.1 | 49.8 | 49.8 | 0.5 | 25.4 | 89 | 238 | 649 | 2.7 |
| Example 1-7* | 10.8 | 43.0 | 46.2 | 46.5 | 0.5 | 43.2 | 87 | 224 | 514 | 2.6 |
| Example 1-8* | — | 48.5 | 51.5 | 51.5 | 0.1 | 69.9 | 75 | 183 | 315 | 2.4 |

¹Polymerization was carried to Final % solids; determined by devolatilization.
²Melt flow index in grams/10 minutes with 5 Kg mass at 200° C. ASTM D1238
³Haze in percent. ASTM D1003
⁴Mol. Wt. data in thousand Daltons by GPC as compared to a polystyrene standard.
⁵Molecular weight distribution determined using GPC. ASTM D-5296
*Not an example of the invention.

TABLE 2

| | MWT | | | | | | | |
|---|---|---|---|---|---|---|---|---|
| | 5 Percent | | 10 Percent | | 15 Percent | | 20 Percent | |
| | FC530 | | FC530 | | FC530 | | FC530 | |
| | No | | No | | No | | No | |
| | NDM | +NDM | NDM | +NDM | NDM | +NDM | NDM | +NDM |
| Mn | 127 | 94 | 111 | 107 | 123 | 106 | 124 | 106 |
| Mw | 350 | 296 | 442 | 317 | 401 | 368 | 430 | 366 |
| Mz | 1005 | 1095 | 2386 | 923 | 1453 | 1365 | 1524 | 1213 |
| MWD | 2.76 | 3.15 | 3.98 | 2.97 | 3.27 | 3.47 | 3.47 | 3.44 |
| Mz/Mn | 7.9 | 5.6 | 21.4 | 8.6 | 11.8 | 12.8 | 12.3 | 11.4 |
| % Solids At | 51.7 | 40.5 | 57.8 | 60.1 | 63.0 | 50.6 | 61.8 | 48.3 |
| End Of | | | | | | | | |
| Run | | | | | | | | |
| % | 46.7 | 35.5 | 47.8 | 50.1 | 48.0 | 35.6 | 41.8 | 28.3 |
| Polystyrene | | | | | | | | |
| At End of | | | | | | | | |
| Run | | | | | | | | |

Mol. Wt. data in thousand Daltons by GPC as compared to a polystyrene standard.

1-30. (canceled)

31. A composition comprising:
a high impact modified polystyrene (HIPS) formed by a process comprising:
dissolving a styrene-conjugated diene-styrene block copolymer in styrene monomer to form a solution; and
polymerizing the solution to form high impact polystyrene; wherein the HIPS exhibits a haze value of about 12 percent or less.

32. The composition of claim 31, wherein the HIPS exhibits a honeycomb morphology.

33. The composition of claim 31, wherein the HIPS exhibits a rubber particle size of from about 5 μ to about 15 μ.

35. The composition of claim 31, wherein the styrene-conjugated diene-styrene block copolymer is linear.

35. The composition of claim 31, wherein the conjugated diene comprises butadiene.

36. The composition of claim 31, wherein the HIPS exhibits a haze value of about 8 percent or less.

37. The composition of claim 35, wherein the styrene-butadiene-styrene block copolymer is represented by the general formula:
S—B—S
wherein S comprises styrene and B is selected from butadiene, isoprene or combinations thereof.

38. The composition of claim 31, wherein the styrene-conjugated diene-styrene block copolymer comprises a molecular weight of from about 2,000 Daltons to about 300,000 Daltons.

39. The composition of claim 31, wherein the styrene-conjugated diene-styrene block copolymer comprises at least 50 wt. % styrene.

40. The composition of claim 31, wherein the HIPS exhibits an Mz/Mn of at least 4.1.

41. The composition of claim 31, wherein the HIPS exhibits an Mz/Mn of from about 5.5 to about 25.

42. The composition of claim 31, wherein the HIPS exhibits a melt flow index of from about 2 to about 6 g/10 min.

43. The composition of claim 31, wherein the HIPS exhibits a melt flow index of from about 6 to about 14 g/10 min.

44. A composition comprising:
high impact modified polystyrene (HIPS) formed by a process comprising:
dissolving a styrene-conjugated diene-styrene block copolymer in styrene monomer; and
polymerizing the styrene monomer;
wherein the HIPS exhibits a haze value of about 12 percent or less and a rubber particle size of from about 5 μ to about 15 μ.

45. A polymerization process comprising:
dissolving a styrene-conjugated diene-styrene block copolymer in styrene monomer to form a solution; and
polymerizing the solution to form high impact polystyrene; wherein the HIPS exhibits a haze value of about 12 percent or less.

46. The process of claim 45, wherein the styrene-conjugated diene-styrene block copolymer is linear.

47. The process of claim 45, wherein the conjugated diene comprises butadiene.

48. The process of claim 45,wherein the styrene-butadiene-styrene block copolymer is represented by the general formula:
S—B—S
wherein S comprises styrene and B is selected from butadiene, isoprene or combinations thereof.

49. The process of claim 45, wherein the styrene-conjugated diene-styrene block copolymer comprises a molecular weight of from about 2,000 Daltons to about 300,000 Daltons.

50. The process of claim 45, wherein the styrene-conjugated diene-styrene block copolymer comprises at least 50 wt. % styrene.

51. The process of claim 45, wherein the HIPS exhibits an Mz/Mn of at least 4.1.

52. The process of claim 45, wherein the HIPS exhibits an Mz/Mn of from about 5.5 to about 25.

53. The process of claim 45, wherein the HIPS exhibits a melt flow index of from about 2 to about 6 g/10 min.

54. The process of claim 45, wherein the HIPS exhibits a melt flow index of from about 6 to about 14 g/10 min.
